(19) United States
(12) Patent Application Publication
(10) Pub. No.: US 2006/0053918 A1
(43) Pub. Date: Mar. 16, 2006

(54) Plastic gear and plastic compound gear

(76) Inventors: Tsuneo Asari, Chino-city (JP); Fumio Emori, Chino-city (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/215,166

(22) Filed: Aug. 30, 2005

(30) Foreign Application Priority Data
Aug. 31, 2004 (JP) JP 2004-251424

(51) Int. Cl. F16H 1/14

(52) U.S. Cl. 74/423

(57) ABSTRACT

A plastic gear and a plastic compound gear that can endure excessive loads without degrading gear precision. In the plastic compound gear, both a large diameter gear and a small diameter gear have a plurality of ribs that are respectively connected to teeth root portions with the outer end portions thereof. The ribs are inclined to one side (counterclockwise) in the circumferential direction viewed from a longitude line that passes through the gear center. Therefore, when the compound gear used as a drive gear with respect to two secondary gears are rotated about a boss counterclockwise to rotate the secondary gears clockwise, the inclination of the ribs works against the force that is applied to the teeth root portion.

### FIELD OF THE INVENTION

The present invention relates to a plastic gear and a plastic compound gear that are used for precision drive systems in OA machines, such as printers and copy machines, and automotive wind regulators.

### BACKGROUND OF THE INVENTION

A plastic gear used for precision drive systems in OA machines such as printers and copy machines and automotive wind regulators is formed such that a teeth portion is formed around the outer circumference of the gear and the inner area inner of the teeth root portion is reduced in thickness to form a thin web. In the web, a plurality of ribs are formed in the radial direction to add more rigidity (See Patent References 1, 2, 3 and 4, for example).

FIGS. 5 (a) and 5(b) show a conventional example of a plastic gear 300 of this kind. The plastic gear 300 has a cylindrical boss 302 in the gear center and a teeth portion 303 around the outer circumference thereof. Also, the inner area of a teeth root portion 330 of the plastic gear 300 is formed as a thin web 305. In addition, two annular rims 341, 342 are formed to divide the web 305 into three concentric annular web portions 351, 352 and 353. Further, a plurality of ribs 361, 362, and 363 which extend in the radial direction are respectively formed to the annular web portions 351, 352, and 353.

When a plastic gear 300 configured as above is used as a drive gear or a secondary gear, a force in the direction of a tangent line is exerted on the teeth portion 303. Therefore, a large force (a shearing force) in the direction orthogonal to the ribs 363 is exerted on the outmost ribs 363, which are connected to the teeth root portion 330 with the outer end portions thereof, at the mating portion of the teeth. Therefore, if an excessive load such as a shock-like rotational torque is applied to the plastic gear 300, the connection between the teeth portion 303 and the ribs 363, or the ribs themselves 363 may be damaged.

To prevent the above mentioned problem, the number of the outmost ribs 363 may be increased or the connection between the ribs 363 and the teeth root portion 330 may be formed thicker. However, such configurations bring problems such as shrinkage cavity of the ribs 363 during the resin-molding of the ribs, degrading the dimensional and shape precision of the teeth portion 303.

To solve the above problems, an objective of the present invention is to propose a plastic gear that endures excessive loads without degrading the gear precision.

### SUMMARY OF THE INVENTION

To achieve the above objective, a plastic gear of the present invention is a plastic gear having a teeth portion formed around the outer circumference thereof and a thin web formed in the inner area of a teeth root portion of the teeth portion, wherein in the web, a plurality of ribs, which are connected to the teeth root portion with the outer end portions, are formed around the outer circumference at a predetermined distance in the circumferential direction, and the ribs around the outer circumference are inclined to one side in the circumferential direction viewed from a longitude line that passes through the gear center.

The present invention has ribs around the outer circumference which are inclined to one side in the circumferential direction viewed from a longitude line D that passes through the gear center. Therefore, when the plastic gear is used as a drive gear or a secondary gear, the inclination of the ribs works against the force which is applied (to the teeth portions). Thus, a shearing force that is applied to the ribs around the outer circumference can be reduced to small or no shearing force is applied to the ribs around the outer circumference. For this reason, even when an excessive load such as a shock-like rotation torque is exerted on the plastic gear, the connection between the teeth root portion and the ribs around the outer circumference or the ribs themselves are prevented from being damaged. As a result, there is no need to increase the number of the ribs around the outer circumference in order to increase the strength of the ribs around the outer circumference, and also, the connection between the ribs around the outer circumference and the teeth portion does not need to be formed thicker; therefore, even if resin shrinkage occurs in the ribs around the outer circumference when the plastic gear is resin-molded, the teeth portion is not affected easily. Moreover, since the ribs around the outer circumference are inclined, the resin shrinkage in the ribs does not center on the specific location of the teeth portion in the circumferential direction. Consequently, since the shape and dimensional precision of the teeth portion are not degraded due to the ribs around the outer circumference, a plastic gear that can endure excessive loads can be provided without degrading gear precision.

In the present invention, the web has an annular rim concentric to the gear center between the gear center and the teeth root portion, and a plurality of ribs, which are connected to the annular rim with the outer end portions thereof, are formed around the inner circumference at a predetermined distance in the circumferential direction. The ribs around the inner circumference are inclined to one side in the circumferential direction viewed from a longitude line that passes through the gear center. This configuration can increase the strength of the inner circumference of the plastic gear.

In another embodiment of the present invention, a plastic gear has a teeth portion formed around the outer circumference thereof and a thin web formed in the inner area of a teeth root portion of the teeth portion; a plurality of first ribs around the outer circumference and second ribs around the outer circumference are connected to the teeth root portion with the outer end portions thereof and are alternately arranged in the circumferential direction, the first ribs around the outer circumference are inclined to one side in the circumferential direction viewed from a longitude line that passes through the gear center, and the second ribs around the outer circumference are inclined to the other side in the circumferential direction viewed from a longitude line that passes through the gear center.

The present invention has the first ribs and second ribs around the outer circumference which are respectively inclined to one side or to the other in the circumferential direction viewed from a longitude line D that passes through the gear center. Therefore, no matter which circumferential direction a force is exerted on the plastic gear which is used as a drive gear or a secondary gear, the inclination of the ribs around the outer circumference works against such a force. Thus, no matter in which direction an excessive load is applied to the plastic gear, the connections between the teeth root portion and the ribs around the outer circumference or the ribs themselves are prevented from being damaged. Thus, (a plastic gear of the present invention) is suitable to be used as a gear in which the direction of rotation can be switched. Also, there is no need to increase the number of the ribs in order to increase the strength of the ribs, and also the connection between the ribs around the outer circumference and the teeth portion does not need to be formed thicker; therefore, even if resin shrinkage occurs in the ribs around the outer circumference, the teeth portion is not affected easily. Moreover, since the ribs around the outer circumference are inclined, the resin shrinkage in the ribs around the outer circumference does not center on the specific location of the teeth portion in the circumferential direction. Consequently, since the shape and dimensional precision of the teeth portion are not degraded due to the ribs around the outer circumference, a plastic gear that can endure excessive loads can be provided without degrading gear precision.

In the present invention, it is preferred that the first ribs and second ribs around the outer circumference be connected to each other with the inner end portions thereof creating a V shape.

It is preferred in the present invention that in the web, an annular rim concentric with the gear center is formed between the gear center and the teeth root portion; in the inner area of the annular rim, a plurality of first ribs around the inner circumference and second ribs around the inner circumference, which are connected to the annular rim with the outer end portions thereof, are formed alternately in the circumferential direction, the first ribs around the inner circumference are inclined to one side in the circumferential direction viewed from a longitude line that passes through the gear center, and the second ribs around the inner circumference are inclined to the other side in the circumferential direction viewed from a longitude line that passes through the gear center. This configuration can increase the strength of the inner area of the plastic gear.

It is preferred in the present invention that the first ribs and second ribs around the inner circumference be connected to each other with the inner end portions thereof creating a V shape.

In the present invention, the above-mentioned ribs are inclined at an angle of 1° to 45° (generally/approximately) with respect to a longitude line that passes through the gear center.

The present invention can be applied to a plastic compound gear in which a pair of plastic gears are integrally molded to both sides of the web having the web in common.

The plastic gear of the present invention has ribs around the outer circumference which are inclined to one side in the circumferential direction viewed from a longitude line D that passes through the gear center. Therefore only a small shearing force is applied to the ribs around the outer circumference, or no shearing force is exerted on the ribs around the outer circumference. Even when a shock-like rotation torque is caused in the plastic gear, the connection between the teeth root portion and the ribs around the outer circumference or the ribs themselves are prevented from being damaged. Consequently, there is no need to increase the number of the ribs around the outer circumference in order to increase the strength of the ribs around the outer circumference, and also the connections between the ribs around the outer circumference and the teeth portion do not need to be formed thicker; therefore, even if resin shrinkage occurs in the ribs around the outer circumference, the teeth portion is not affected easily. Moreover, since the ribs around the outer circumference are inclined, the resin shrinkage in the ribs around the outer circumference does not center on the specific location of the teeth portion in the circumferential direction. Consequently, since the shape and dimensional precision of the teeth portion are not degraded due to the ribs around the outer circumference, a plastic gear that can endure excessive loads can be provided without degrading gear precision. Therefore, the plastic gear of the present invention can be suitably applied to a precision drive system of OA machines such as printers and copy machines as well as a drive system of an automobile wind regulator that requires high rigidity.

An example of a plastic gear to which the present invention is applied is described hereinafter referring to the drawings.

### BRIEF DESCRIPTION OF THE DRAWINGS

FIGS. 1 (a) through 1 (c) are respectively a cross-section of a plastic gear of Embodiment 1 of the present invention, a plan view of the gear viewed from the large diameter gear side, and another plan view of the gear viewed from the small diameter gear side.

FIGS. 2 (a) through 2 (c) are respectively a cross-section of a plastic gear of Embodiment 2 of the present invention, a plan view of the gear viewed from the large diameter gear side, and another plan view of the gear viewed from the small diameter gear side.

FIGS. 3 (a) through 3 (c) are respectively a cross-section of a plastic gear of Embodiment 3 of the present invention, a plan view of the gear viewed from the large diameter gear side, and another plan view of the gear viewed from the small diameter gear side.

FIGS. 4 (a) through 4 (c) are respectively a cross-section of a plastic gear of Embodiment 4 of the present invention, a plan view of the gear viewed from the large diameter gear side, and another plan view of the gear viewed from the small diameter gear side.

FIGS. 5 (a) and 5 (b) are respectively a plan view and a cross-section of a conventional plastic gear.

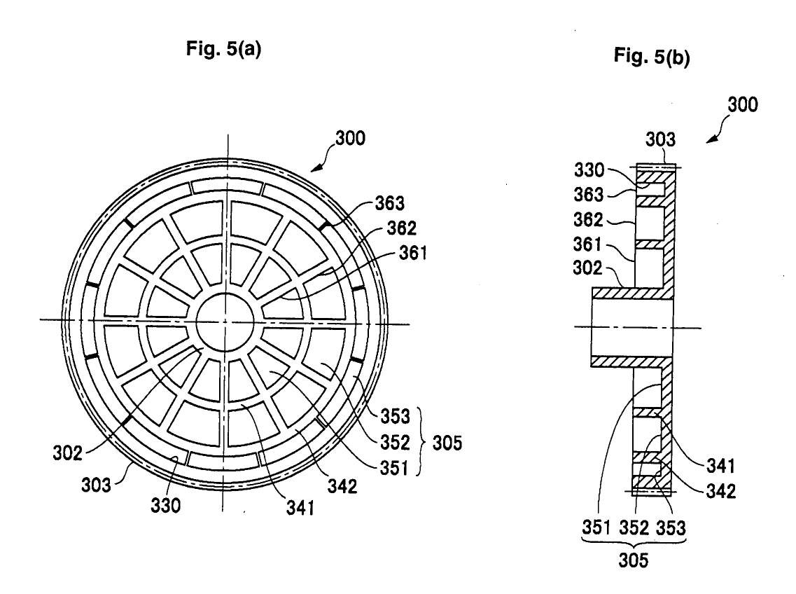

### DETAILED DESCRIPTION OF THE DRAWINGS

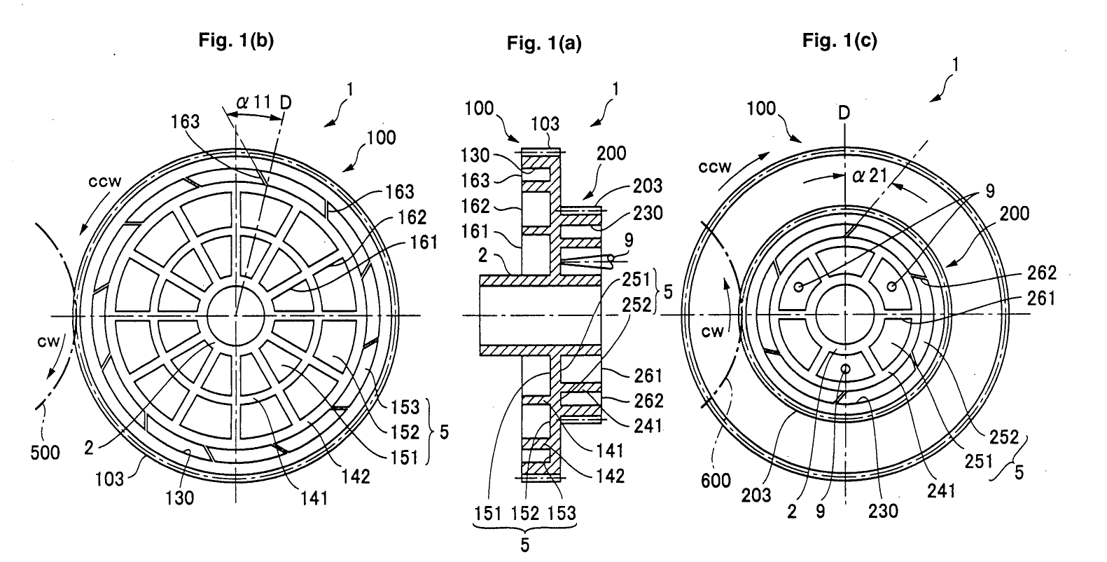

FIGS. 1 (a) through 1 (c) are respectively a cross-section of a plastic gear of Embodiment 1 of the present invention, a plan view of the gear viewed from the large diameter gear side, and a plan view of the gear viewed from the small diameter gear side.

As shown in FIGS. 1 (a) through 1 (c), a plastic compound gear 1 of this embodiment is a compound gear in which a large diameter plastic gear 100 and a small diameter plastic gear 200 are integrally molded of resin such as POM (polyoxymethylene) sharing a web 5; a cylindrical boss 2 is formed in the gear center. Also in the plastic compound gear 1 of this embodiment, the large diameter plastic gear 100 has a teeth portion 103 around the outer circumference thereof and the small diameter plastic gear 200 has a teeth portion 203 around the outer circumference thereof; the area between the boss 2 and the teeth portion 103 and the area between the boss 2 and the teeth portion 203 (the inner area of the teeth root portion 130, 230) are reduced in thickness to form a thin web 5.

In the large diameter gear 100, the web 5 has a plurality of thick annular rims 141 and 142, which are concentrically formed to divide the web 5 into a plurality of concentric annular web portions 151, 152 and 153. In this embodiment, two annular rims 141 and 142 form three annular web portions 151, 152, and 153.

To the inmost annular web portion 151, a plurality of ribs 161 are arranged in the radial direction. The ribs 161 are connected to the boss 2 with the inner end portions thereof and to the annular rim 141 with the outer end portions thereof. In this embodiment, there are twelve ribs 161 formed at an equal angle and distance. In the same manner, a plurality of ribs 162 are formed in the radial direction to the annular web portion 152 which is the second from the inmost web portion. The ribs 162 are connected to the annular rim 141 with the inner end portions thereof and to the annular rim 142 with the outer end portions thereof. In this embodiment, there are twelve ribs 161 formed at an equal angle and distance. Also, the ribs 161 and 162 are formed at the same angular positions.

In the same manner, a plurality of thin ribs 163 (the ribs around the outer circumference) having a width of 0.3 mm-2.0 mm are arranged at an equal angle and distance in the outmost annular web portion 153. The ribs 163 are connected to the annular rim 142 with the inner end portions thereof and to the teeth root portion 130 with the outer end portions thereof. In this embodiment, there are twelve ribs 163 formed at an equal angle and distance. Also, each of the ribs 163 is formed to be positioned in the middle of the adjacent ribs 161, 162.

In the large diameter plastic gear 100 configured as above, the ribs 163 are inclined to one side in the circumferential direction (counterclockwise, ccw) viewed from a longitude line D that passes through the gear center. The inclination α11 of the rib 163 to the longitude line D is set between 1° and 45° (generally/approximately).

In the small diameter plastic gear 200, the web 5 has a thick annular rim 241, which divides the web 5 into a plurality of concentric annular web portions 251 and 252. In this embodiment, a single annular rim 241 creates two annular web portions 251 and 252.

In the annular web portion 251 on the inner side, a plurality of ribs 261 are arranged in the radial direction. The ribs 261 are connected to the boss 2 with the inner end portions thereof and to the annular rim 241 with the outer end portions thereof. In this embodiment, there are six ribs 261 arranged at an equal angle and distance. Further, a plurality of pin point gates 9 that are used when the plastic gear 1 is injection-molded inside a mold are arranged at an equal angle and distance in the annular web portion 251. In this embodiment, the pin point gates 9 are arranged at three locations.

In the same manner, a plurality of ribs 262 (the ribs around the outer circumference) are arranged in the annular web portion 252 on the outer side. The ribs 262 are connected to the annular rim 241 with the inner end portions thereof and to the teeth root portion 230 with the outer end portions thereof. In this embodiment, there are six ribs 262 formed at an equal angle and distance. Also, each of the ribs 262 is positioned to be in the middle of the adjacent ribs 261.

In the small diameter plastic gear 200 configured as above, the ribs 262 are inclined to one side in the circumferential direction (counterclockwise, ccw) viewed from a longitude line D that passes through the gear center. The inclination α21 of the rib 262 with respect to the longitude line D is set between 1° and 45° (generally/approximately).

As described above, the plastic compound gear 1 of this embodiment is configured such that both the large diameter gear 100 and the small diameter gear 200 respectively have a plurality of ribs 163, 262 (the ribs around the outer circumference); the outer end portions thereof are connected to the teeth root portions 130, 230, and the ribs 163, 262 are inclined to one side in the circumferential direction (counterclockwise, ccw) viewed from a longitude line D that passes through the gear center. Here is an example how the plastic compound gear 1 operates when used as a drive gear with respect to two secondary gears 500 and 600: when the plastic compound gear 1 is rotated counterclockwise (ccw) about the boss 2 to rotate the secondary gears 500 and 600 clockwise (cw), the inclination of the ribs 163 and 262 works against the force which is applied to the teeth portions 130 and 230. Thus, although the force is applied to the teeth portions 103, 203 in the direction of the tangent, only a small force (a shearing force) would be exerted on the ribs 163, 262 in the direction orthogonal to the ribs or no shearing force would be applied. Therefore, even when excessive load such as a shock-like rotation torque is exerted on the plastic gears 100 and 200, the connections between the teeth root portions 130, 230 and the ribs 163, 262, or the ribs 163, 262 themselves are prevented from being damaged. As a result, there is no need to increase the number of the ribs 163, 262 in order to increase the strength of the ribs 163, 262. Also, since the connections between the ribs 163, 262 and the teeth root portions 130, 203 do not need to be formed thicker, even if resin shrinkage occurs in the ribs 163, 262 when the plastic compound gear 1 is resin-molded, the teeth portions 103, 203 are not affected easily. Moreover, since the ribs 163, 262 are inclined, the resin shrinkage in the ribs 163, 262 does not center on the specific location of the teeth portions 103, 203 in the circumferential direction. In this manner, the shape and dimensional precision of the teeth portions 103, 203 are not degraded because of the ribs 163, 262, and a plastic compound gear 1 that can endure excessive loads can be provided without degrading the shape and dimensional precision of the teeth portions 103, 203.

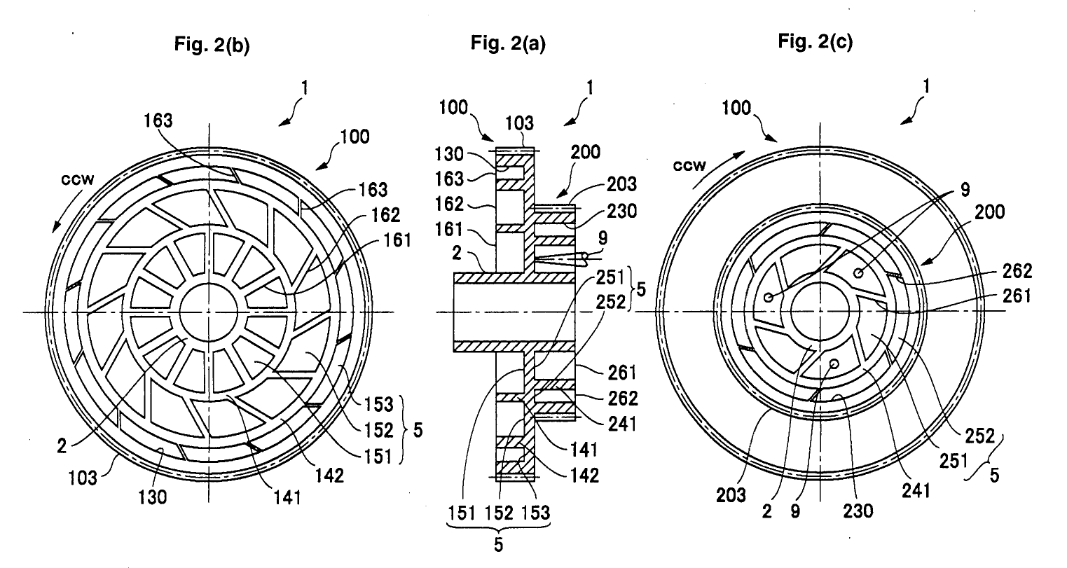

FIGS. 2 (a) through 2 (c) are respectively a cross-section of a plastic gear of Embodiment 2 of the present invention, a plan view of the gear viewed from the large diameter gear side, and a plan view of the gear viewed from the small diameter gear side. Note that since the basic configuration of a plastic gear of this embodiment is common with that of Embodiment 1, the common portions are given the same codes and their descriptions are omitted.

As shown in FIGS. 2 (a) through 2 (c), a plastic compound gear 1 of this embodiment is a compound gear in which a large diameter plastic gear 100 and a small diameter plastic gear 200 are integrally molded having a web 5 in common in the same manner as Embodiment 1; a cylindrical boss 2 is formed in the gear center.

In the large diameter gear 100, twelve ribs 163 (the ribs around the outer circumference) in the outmost annular web portion 153 are inclined to one side in the circumferential direction (counterclockwise, ccw) viewed from a longitude line D that passes through the gear center. Note that the inclination of the rib 163 with respect to the longitude line D is set between 1° and 45° (generally/approximately). In this embodiment, twelve ribs 162 (the ribs on the inner side) in the second inmost annular web 152 are also inclined to one side in the circumferential direction (counterclockwise, ccw) viewed from a longitude line that passes through the gear center in the same manner as the ribs 163. Note that the inclination of the rib 162 with respect to the longitude line is also set between 1° and 45° in the same manner as that of the rib 163.

In the small diameter gear 200, six ribs 262 (the ribs around the outer circumference) in the outer annular web portion 252 are inclined to one side in the circumferential direction (counterclockwise, ccw) viewed from a longitude line D that passes through the gear center. Note that the inclination of the rib 262 with respect to a longitude line is set between 1° and 45° (generally/approximately). Further, in this embodiment, six ribs 261 (the ribs around the inner circumference) in the inner annular web 251 are also inclined to one side in the circumferential direction (counterclockwise, ccw) viewed from a longitude line that passes through the gear center. Note that the inclination of the rib 261 with respect to a longitude line is also set between 1° and 45° (generally/approximately) in the same manner as that of the rib 262. Other configurations remain the same as those of Embodiment 1.

The plastic compound gear 1 of this embodiment configured as above operates in the following manner: when the secondary gears 500 and 600 which are illustrated in FIG. 1 are rotated clockwise, cw, in the same manner as in Embodiment 1, the inclination of the ribs 163 and 262 works against the force that is applied to the teeth portions 130 and 230. Therefore, the connections between the teeth root portions 130, 230 and the ribs 163, 262, or the ribs 163, 262 themselves are prevented from being damaged. Thus, the same effect as that of Embodiment 1 can be obtained. Since the inclination structure which is the same as that of the ribs 163, 262 is applied to the ribs 162, 261 around the inner circumferences in this embodiment, the strength of the inner area can also be improved.

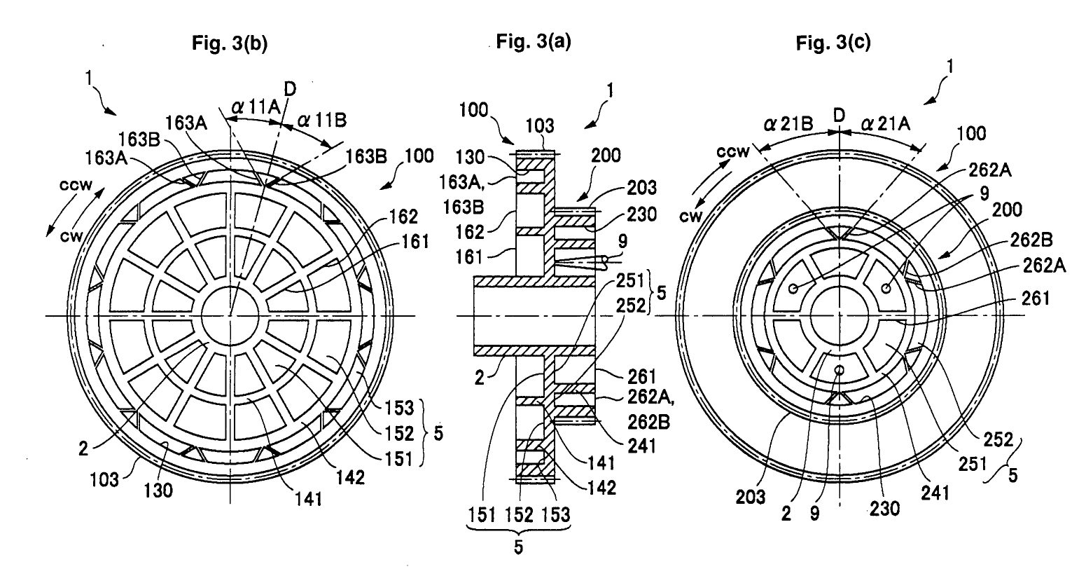

FIGS. 3 (a) through 3 (c) are respectively a cross-section of a plastic compound gear of Embodiment 3 of the present invention, a plan view of the gear viewed from the large diameter gear side, and a plan view of the gear viewed from the small diameter gear side. Note that since the basic configuration of a plastic gear of this embodiment is common with that of Embodiment 1, the common portions are given the same codes and their descriptions are omitted.

As shown in FIGS. 3 (a) through 3 (c), a plastic compound gear 1 of this embodiment is a compound gear in which a large diameter plastic gear 100 and a small diameter plastic gear 200 are integrally molded having a web 5 in common; a cylindrical boss 2 is formed in the gear center.

In the large diameter gear 100, twelve ribs 161 are arranged in the radial direction in the inmost annular web portion 151. The ribs 161 are connected to the boss 2 with the inner end portions thereof and to the annular rim 141 with the outer end portions thereof. Also, twelve ribs 162 are arranged in the radial direction in the annular web portion 152 which is the second from the inmost. The ribs 162 are connected to the annular rim 141 with the inner end portions thereof and to the annular rim 142 with the outer end portions thereof.

In the same manner, twelve ribs 163A (the first ribs around the outer circumference) are arranged at an equal angle and distance in the outmost annular web portion 153. The ribs 163A are connected to the annular rim 142 with the inner end portions thereof and to the teeth root portion 130 with the outer end portions thereof. In this embodiment, the ribs 163A are inclined to one side in the circumferential direction (counterclockwise, ccw) viewed from a longitude line D that passes through the gear center. The inclination α11A of the rib 163A with respect to a longitude line D is set between 1° and 45° (generally/approximately).

In addition, in the outmost annular web portion 153, twelve ribs 163B (the second ribs around the outer circumference) are also arranged adjacent to the ribs 163A at an equal angle and distance but clockwise, cw. The ribs 163A and the ribs 163B are arranged alternately. The ribs 163B are also connected to the annular rim 142 with the inner end portions thereof and to the teeth root portion 130 with the outer end portions thereof. The ribs 163B are inclined to the other side in the circumferential direction (clockwise, cw) viewed from a longitude line D that passes through the gear center. In other words, the ribs 163B are inclined in the direction opposite that of the ribs 163A. And the ribs 163A and 163B are connected to each other with inner end portions thereof creating a V shape. Note that the inclination α11B of the rib 163B with respect to a longitude line D is set between 1° and 45° (generally/approximately).

In the small diameter gear 200, six ribs 261 are arranged in the radial direction in the annular web portion 251 on the inner side. The ribs 261 are connected to the boss 2 with the inner end portions thereof and to the annular rim 241 with the outer end portions thereof. Also, a plurality of pin point gates 9, which are used when a plastic gear 1 is injection-molded in a mold, are arranged at an equal angle and distance in the annular web portion 251. In this embodiment, the pin point gates 9 are arranged at three locations.

In the same manner, six ribs 262A (the first ribs around the outer circumference) are arranged at an equal angle and distance in the annular web portion 252 on the outer side. The ribs 262A are connected to the annular rim 241 with the inner end portions thereof and to the teeth root portion 230 with the outer end portions thereof. In this embodiment, the ribs 262A are inclined to one side in the circumferential direction (counterclockwise, ccw) viewed from a longitude line D that passes through the gear center. The inclination α21A of the rib 262A with respect to a longitude line D is set between 1° and 45° (generally/approximately).

Also, in the annular web portion 252 on the outer side, six ribs 262B (the second ribs around the outer circumference) are arranged adjacent to the ribs 262A at an equal angle and distance but clockwise, cw. The ribs 262A and the ribs 262B are arranged alternately. The ribs 262B are also connected to the annular rim 241 with the inner end portions thereof and to the teeth root portion 230 with the outer end portions thereof. The ribs 262B are inclined to the other side in the circumferential direction (clockwise, cw) viewed from a longitude line D that passes through the gear center. In other words, the ribs 262B are inclined in the direction opposite that of the ribs 262A. And the ribs 262A and 262B are connected to each other with inner end portions thereof creating a V shape. Note that the inclination α21B of the rib 262B with respect to a longitude line D is set between 1° and 45° (generally/approximately).

As described above, the plastic compound gear 1 of this embodiment is configured such that both the large diameter gear 100 and the small diameter gear 200 respectively have a plurality of ribs 163A, 163B, 262A, 262B, which are connected to the teeth root portions 130, 230 with the outer end portions thereof, and the ribs 163A, 163B, 262A, 262B are inclined to one side (counterclockwise, ccw) or to the other (clockwise, cw) in the circumferential direction viewed from a longitude line D that passes through the gear center. When the plastic compound gear 1, used as a drive gear with respect to two secondary gears 500 and 600 illustrated in FIG. 1, is operated to rotate the secondary gears 500 and 600 clockwise cw, the inclination of the ribs 163A and 262A works against the force which is applied to the teeth root portions 130 and 230. In the same manner, when the secondary gears 500, 600 illustrated in FIG. 1 are rotated counterclockwise, ccw, the inclination of the ribs 163B, 262B works against the force which is applied to the teeth root portions 130, 230. Thus, no matter in which direction the plastic compound gear 1 is rotated, only a small shearing force or no shearing force at all is applied to the ribs 163A, 163B, 262A, 262B. Therefore, even when an excessive load such as a shock-like rotation torque is exerted on the plastic gears 100 and 200, the connections between the teeth root portions 130, 230 and the ribs 163A, 163B, 262A, 262B, or the ribs themselves 163A, 163B, 262A, 262B are prevented from being damaged. As a result, there is no need to increase the number of ribs 163A, 163B, 262A, 262B in order to improve the strength of the ribs 163A, 163B, 262A, 262B. Also, since the connections between the ribs 163A, 163B, 262A, 262B and the teeth root portions 130, 203 do not need to be formed thicker, even if resin shrinkage occurs in the ribs 163A, 163B, 262A, 262B when the plastic compound gear 1 is resin-molded, the teeth portions 103, 203 are not affected easily.

Moreover, since the ribs 163A, 163B, 262A, 262B, are inclined, the resin shrinkage in the ribs 163A, 163B, 262A, 262B does not center on the specific location of the teeth portions 103, 203 in the circumferential direction. Consequently, since the shape and dimensional precision of the teeth portions 103, 203 will not be degraded because of the ribs 163A, 163B, 262A, 262B, a plastic compound gear 1 that can endure excessive loads can be provided without degrading gear precision.

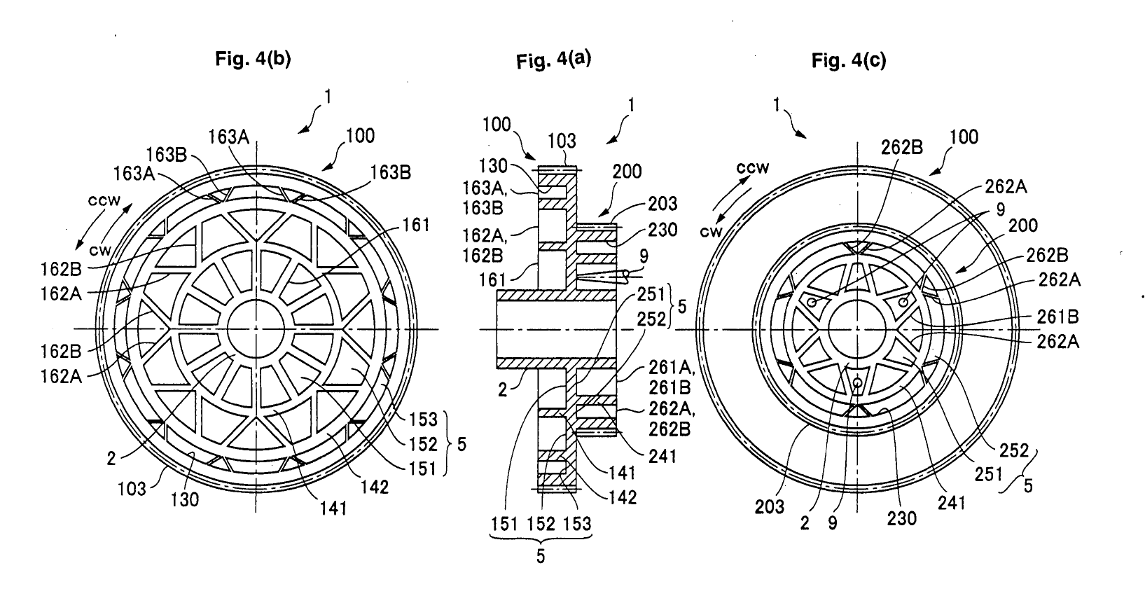

FIGS. 4 (a) through 4 (c) are respectively a cross-section of a plastic gear of Embodiment 4 of the present invention, a plan view of the gear viewed from the large diameter gear side, and a plan view of the gear viewed from the small diameter gear. Note that since the basic configuration of a plastic gear of this embodiment is common with that of Embodiment 3, the common portions are given the same codes and their descriptions are omitted.

As shown in FIGS. 4 (a) through 4 (c), a plastic compound gear 1 of this embodiment is a compound gear in which a large diameter plastic gear 100 and a small diameter plastic gear 200 are integrally molded having a web 5 in common in the same manner as Embodiments 1, 2 and 3; a cylindrical boss 2 is formed in the gear center.

In the large diameter gear 100, formed in the outmost annular web portion 153 are the ribs 163A, 163B which are respectively inclined to one direction (counterclockwise, ccw) or to the other (clockwise, cw) in the circumferential direction viewed from a longitude line D that passes through the gear center.

Also, in this embodiment, formed in the annular web portion 152 on the second from the inmost web portion are the ribs 162A, 162B which are respectively inclined to one direction (counterclockwise, ccw) or to the other (clockwise, cw) in the circumferential direction viewed from a longitude line D that passes through the gear. The ribs 162A and the ribs 162B are arranged alternately and connected to the annular rim 142 with the outer end portions thereof and to each other with the inner end portions thereof creating a V shape. Note that the inclination of the rib 162A, 162B with respect to a longitude line D is set between 1° and 45° (generally/approximately).

In the small diameter gear 100, formed in the outer annular web portion 252 are the ribs 262A, 262B which are respectively inclined to one direction (counterclockwise, ccw) or to the other (clockwise, cw) in the circumferential direction viewed from a longitude line D that passes through the gear center.

Also, in this embodiment, formed in the inner annular web portion 251 are the ribs 261A, 261B which are respectively inclined to one direction (counterclockwise, ccw) or to the other (clockwise, cw) in the circumferential direction viewed from a longitude line D that passes through the gear center. The ribs 261A and the ribs 261B are arranged alternately in the circumferential direction and are connected to the annular rim 241 with the outer end portions thereof and to each other with the inner end portions thereof creating a V shape. Note that the inclination of the rib 261A, 261B with respect to a longitude line D is set between 1° and 45° (generally/approximately).

When the plastic compound gear 1 of this embodiment configured as above is operated to rotate the secondary gears 500 and 600 illustrated in FIG. 1 clockwise cw or counterclockwise ccw, the inclination of the ribs 163A, 163B, 262A, 262B works against the force which is applied to the teeth portions 130 and 230, in the same manner as Embodiment 3. Therefore, the connections between the teeth root portions 130, 230 and the ribs 163A, 163B, 262A, 262B, or the ribs themselves 163A, 163B, 262A, 262B are prevented from being damaged. Thus, the same effect as Embodiment 3 can be obtained. Further, the inclination structure which is the same as that of the ribs 163A, 163B, 262A, 262B is used for the ribs 162A, 162B, 261A, 261B on the inner side; therefore, the strength in the inner area can also be improved.

Note that although the ribs around the outmost circumference are connected to the annular rim with the inner end portions thereof in any of the above embodiments, the inner end portions of the ribs may be connected to the boss 2 if the annular rim is not formed due to the small diameter of the gear. Also, although the above embodiments use a compound gear as a plastic gear, the present invention may be applied to a plastic gear that has only one gear. Further, although the above embodiments use a plastic gear as a drive gear, the present invention may be applied to a secondary gear; the direction in which the ribs are inclined can be determined according to the direction in which the force is applied.

What is claimed is:

1. A plastic gear having a teeth portion formed around the outer circumference thereof and a thin web formed in the inner area of a teeth root portion of said teeth portion,
wherein in said web, a plurality of ribs, which are connected to said teeth root portion with the outer end portions thereof, are formed around the outer circumference at a predetermined distance in the circumferential direction, and said ribs around the outer circumference are inclined to one side in the circumferential direction viewed from a longitude line that passes through the gear center.

2. The plastic gear as set forth in claim 1, wherein said web has an annular rim concentric to the gear center between said gear center and said teeth root portion, and in the inner area of said annular rim, a plurality of ribs, which are connected to said annular rim with the outer end portions thereof, are formed around the inner circumference at a predetermined distance in the circumferential direction, said ribs being inclined to one side in the circumferential direction viewed from a longitude line that passes through the gear center.

3. A plastic gear comprising:
a teeth portion formed around the outer circumference thereof; and
a thin web formed in the inner area of a teeth root portion of said teeth portion,
wherein in said web, a plurality of first ribs and second ribs that are connected to said teeth root portion with the outer end portions thereof are alternately formed around the outer circumference, said first ribs around the outer circumference being inclined to one side in the circumferential direction viewed from a longitude line that passes through the gear center, and said second ribs around the outer circumference being inclined to the other side in the circumferential direction viewed from a longitude line that passes through the gear center.

4. The plastic gear as set forth in claim 3, wherein said first ribs and second ribs around the outer circumference are connected to each other with the inner end portions thereof creating a V shape.

5. The plastic gear as set forth in claim 3, wherein in said web, an annular rim concentric with the gear center is formed between the gear center and said teeth root portion; in the inner area of said annular rim, a plurality of first ribs and second ribs, which are connected to said annular rim with the outer end portions thereof, are formed alternately around the inner circumference, said first ribs around the inner circumference being inclined to one side in the circumferential direction viewed from a longitude line that passes through the gear center, and said second ribs around the inner circumference being inclined to the other side in the circumferential direction viewed from a longitude line that passes through the gear center.

6. The plastic gear as set forth in claim 5, wherein said first ribs and said second ribs around the inner circumference are connected to each other with the inner end portions thereof creating a V shape.

7. The plastic gear as set forth in claim 1, wherein said ribs are inclined at an angle of between 1° and 45° with respect to a longitude line that passes through the gear center.

8. A plastic compound gear as set forth in claim 1, wherein a pair of plastic gears are integrally molded to both sides of said web having said web in common.
